(19) United States
(12) Patent Application Publication
(10) Pub. No.: US 2023/0334364 A1
(43) Pub. Date: Oct. 19, 2023

(54) N-1 EXPERTS: MODEL SELECTION FOR UNSUPERVISED ANOMALY DETECTION

(71) Applicant: Oracle International Corporation, Redwood Shores, CA (US)

(72) Inventors: Yasha Pushak, Vancouver (CA); Robert Wayne Harlow, Madison, WI (US); Constantin Le Clei, Zurich (CH); Hesam Fathi Moghadam, Sunnyvale, CA (US); Sungpack Hong, Palo Alto, CA (US); Hassan Chafi, San Mateo, CA (US)

(21) Appl. No.: 18/075,667

(22) Filed: Dec. 6, 2022

Related U.S. Application Data
(60) Provisional application No. 63/331,588, filed on Apr. 15, 2022.

(51) Int. Cl. G06N 20/00

(52) U.S. Cl. CPC G06N 20/00

(57) ABSTRACT

In an embodiment in a computer, each of several anomaly detectors infers a respective anomaly inference for each of many test tuples. For each available anomaly detector that is not the candidate anomaly detector, a respective fitness score is measured for the candidate anomaly detector that indicates how similar are anomaly inferences of the candidate anomaly detector to anomaly inferences of the available anomaly detector. Fitness scores of the candidate anomaly detector are combined into a combined fitness score for the candidate anomaly detector. The best anomaly detector that has a highest combined fitness score is selected for further operation such as inferring an anomaly inference for a new tuple while retraining or in production.

### CROSS-REFERENCE TO RELATED APPLICATION; BENEFIT CLAIM

This application claims the benefit of Provisional Appln. 63/331,588, filed Apr. 15, 2022, the entire contents of which is hereby incorporated by reference as if fully set forth herein, under 35 U.S.C. §119(e).

### FIELD OF THE INVENTION

The present invention relates to model selection for machine learning (ML). Herein is unsupervised empirical ranking of ML models.

### BACKGROUND

Solving a machine learning (ML) task often requires heavy engineering work in order to find a well-suited model and hyperparameters values. The best configuration is often different from one dataset to another, which renders hyperparameters tuning particularly time consuming and resource expensive. Dealing with a new dataset also requires sufficient ML expertise, which some users and companies might not have. Automated ML (AutoML) tries to reduce the engineering overhead by automating different elements of the traditional ML pipeline, such as feature selection, model selection, and hyperparameter tuning. In the last two decades, advances in AutoML have been mainly limited to supervised learning tasks such as regression and classification, where the training data is labelled. In such scenarios at training time, the labels are typically compared against model predictions to produce informative validation scores that facilitate comparative evaluation and discovery of the best model and hyperparameter configuration.

However, AutoML for unsupervised learning, and in particular unsupervised anomaly detection (UAD), remains largely unexplored. A big issue is lack of access to ground-truth labels for training. There is no obvious metric for evaluating and comparing models and hyperparameters configurations. Previous methods include performing meta-training of a metamodel prior to encountering a new dataset, or scoring a model according to an unsupervised metric, which may be unreliable in various scenarios.

UAD is the problem of finding outliers in a set of points, without being given any ground-truth labels (and therefore any information about what an anomaly should look like). Using ML to solve this task requires different solutions compared to supervised anomaly detection, where an additional training set of labeled points is available. A limited approach is to use a single ML model. Existing models and algorithms for UAD include Sklearn or PyOd. UAD is a difficult and somewhat vague problem by nature, for at least the following reasons.
There is no general objective function.
The definition of an outlier may vary for different datasets and even for different uses one makes of a single dataset.

On top of the above enumerated difficulties, one main challenge is that the true proportion of anomalies in the dataset, called the contamination factor, is usually unknown. Some previously mentioned approaches set it to a fixed value, which may not be correct or known in real-application settings. The state of the art does not support automatic determination of the contamination factor. Automatic model selection in the state of the art cannot be reliably performed without knowing the true contamination factor.

Using a selection strategy to choose an accurate model for UAD has recently been implemented by AutoOD. The following are limitations of AutoOD.
The configuration search space is exponentially large, so it cannot be efficiently searched without a heuristic, which could be unreliable on new datasets.
Training many deep autoencoders during the search process requires a large amount of computation.
AutoOD only selects autoencoders, not other types of anomaly detectors.

Meta-learning-based approaches such as MetaOD compare the dataset of interest to a set of historical datasets in order to pick a model. MetaOD first computes the performance of a set of UAD models on different historical datasets, and uses this information to learn specific representations for all those datasets and models. MetaOD uses those metafeatures to predict the best suited model for a new dataset. Microsoft Azure Anomaly Detector uses a meta-learning approach to select between three predetermined model ensembles for UAD. However, this automated ensemble approach is limited to the univariate case in an ML pipeline that uses a single model when dealing with multivariate data.

Meta-learning may be unreliable, especially for real-application datasets that are unlike the collected historical datasets. Given the small number of UAD datasets that are published and the large space of possible datasets that a user might want analyzed, it is a difficult task to reliably choose a model from metafeatures alone. It also requires the historical datasets to be labelled, which is a constraint and may be prone to labeling errors and wrong definitions of the concept of an outlier. Anomalies are by definition unprecedented, so learning from past examples of anomalous behavior may be difficult.

### BRIEF DESCRIPTION OF THE DRAWINGS

In the drawings:

FIG. 1 is a block diagram that depicts an example computer that unsupervised empirically ranks anomaly detectors and selects a best one or more anomaly detectors;

FIG. 2 is a flow diagram that depicts example unsupervised empirical ranking process that a computer may use to select a best one or few anomaly detectors;

FIG. 3 is a flow diagram that depicts example special activities for unsupervised testing by a computer;

FIG. 4 is a block diagram that illustrates a computer system upon which an embodiment of the invention may be implemented;

FIG. 5 is a block diagram that illustrates a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

The present invention relates to model selection for machine learning (ML). Herein is unsupervised empirical ranking of ML models. To select between available models for an unsupervised anomaly detection (UAD) task, each available model is scored by a panel of experts composed of every available model except a candidate model that is being fitness scored. Given any scoring metric, an expert scores a candidate model by evaluating the candidate model’s performance with respect to the predictions the expert produces on the dataset. The overall score of a candidate model is given by the average of all expert scores. Selection of the best model with the highest average expert score occurs automatically. This method is referred to herein as n-1 experts.

The following several intuitive assumptions justify predicting high performance of a model if a consensus of experts prefers the model.
If the candidate model performs well on the labels an expert produces, then the predictions of the candidate model and the expert are similar.
The experts are diverse enough, such that each one contributes a unique perspective on which points are anomalous.
The shortcomings of the experts are sufficiently uncorrelated such that there will be no emphasized mistake.

The set of models may be taken from the most popular anomaly detection (AD) models including open source libraries such as PyOD or sklearn whose models should have a reasonable latent definition of an anomaly. Furthermore for each of those AD methods, the behavior may be consistent with its designer’s opinion about what anomalies should look like. Those designers usually are experts and have considerable experience in the field.

Settling for a single model as in previously mentioned approaches is not general enough to tackle UAD challenges. In order to be widely applicable to diverse use cases, solutions herein may use an automated ML (AutoML) pipeline which, given an arbitrary dataset, aims at picking the best suited model configuration. Herein, AutoML is adapted for the purposes of UAD, and an unsupervised fitness metric is defined that can be used for the model selection and hyperparameter tuning phases of the ML pipeline. The fitness metric is standalone and can be used with or without AutoML.

UAD herein has a fitness metric that is a function that accepts as input a set of predictions and the corresponding set of labels, and returns a score corresponding to some distance between the predictions and labels. That score may be any of: a validation score, an accuracy, an error total, or a similarity or dissimilarity measure. Any of those scores may be used as a fitness score that is scaled from a low of zero to a high of one or 100% that indicates perfect agreement between a set of test inferences and a corresponding set of test labels.

Fitness herein may be any one of the following mutually exclusive classes of metrics.
Binary-binary metric requires the predictions of the model and the labels to be binary predictions (0 or 1). This includes F1-score or balanced accuracy.
Continuous-binary metric requires only the labels to be binary predictions, while predictions can be probabilities (any real number between 0 and 1). This includes area under precision recall curve (AUPRC), area under receiver operating characteristic curve (AUROC), or precision at n (PAN).
Continuous-continuous metric requires neither labels nor predictions to be binary. This includes mean squared error (typically used for regression) or normalized discounted cumulative gain (NDCG).

Distinctions between the above enumerated kinds of fitness metrics may be important when predictions of a model are probabilities, which prevents accurate binary predictions if the contamination factor is unknown. Contamination factor is explained herein. Scores given by binary-binary metrics are often very low and not informative in UAD. Thus, a continuous-binary or continuous-continuous metric may instead be used to evaluate a model.

At least the following aspects of this approach are novel.
Is the first to evaluate candidate models based on their performance with respect to anomaly scores generated by other candidate models.
Uses a continuous-continuous metric or integrates the overall score of a model over a set of possible contamination factors to mitigate the problem of an unknown true contamination factor.
Is general enough to be applied for any kind of parameter selection, including hyper parameter tuning.
Can be accelerated by sub sampling the dataset in order to compute the expert scores.
Uses the average of models instead of a trusted central party in distributed computing.

The following are some advantages of this approach.
Does not require access to ground truth labels.
Does not require knowledge of the true contamination factor for a dataset.
Runs in polynomial time with respect to the number of records in the training corpus and the number of candidate models.
Does not make assumptions about the training corpus. In contrast, other approaches use meta-learning, and thereby assume that new datasets more or less closely resemble training data.
Compared to meta-learning based approaches, does not require any labels from any datasets (meta-learning approach requires ground-truth labels for supervised pre-training the metamodel). The approach herein is not impacted by the possible data mislabeling of past datasets used in meta-learning based approaches.

In an embodiment in a computer, each of several anomaly detectors infers a respective anomaly inference for each of many test tuples. For each available anomaly detector that is not the candidate anomaly detector, a respective fitness score is measured for the candidate anomaly detector that indicates how similar are anomaly inferences of the candidate anomaly detector to anomaly inferences of the available anomaly detector. Fitness scores of the candidate anomaly detector are combined into a combined fitness score for the candidate anomaly detector. The best anomaly detector that has a highest combined fitness score is selected for further operation such as inferring an anomaly inference for a new tuple while retraining or in production.

### 1.0 Example Computer

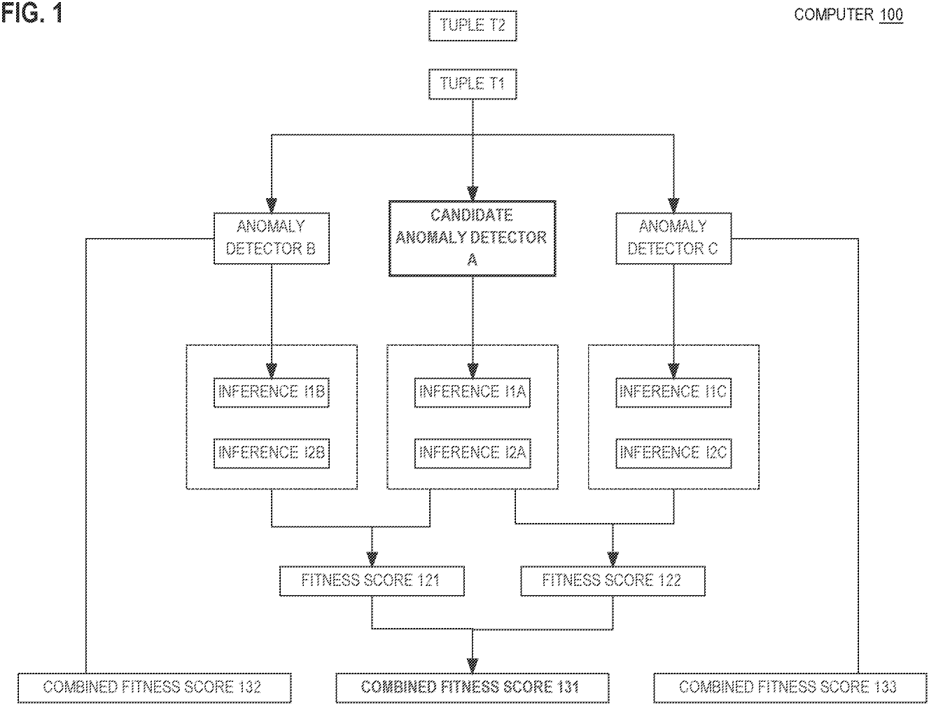

FIG. 1 is a block diagram that depicts an example computer 100. In an embodiment, computer 100 unsupervised empirically ranks anomaly detectors A-C and selects a best one or more anomaly detectors. Computer 100 may be one or more of a rack server such as a blade, a personal computer, a mainframe, or a virtual computer.

This example lacks training, and each of anomaly detectors A-C is not a machine learning (ML) model or is one that is already trained. Another example may entail also training some or all of anomaly detectors A-C based on a training corpus that does or does not contain tuples T1-T2. A respective feature vector that anomaly detectors A-C accept as input is one of tuples T1-T2 or is populated with encoded feature values from tuples T1-T2. In one example, anomaly detectors B-C have different respective values for a same set of hyperparameters of an ML algorithm. In other words, anomaly detectors B-C may be differently configured model instances of a same ML algorithm.

In batches or individually in a stream, each of anomaly detectors A-C accepts tuples T1-T2 as separate inputs that cause anomaly detectors to generate respective inferences I1A-I2A, I1B-I2B, and I1C-I2C. For example, anomaly detector C infers inferences I1C-I2C from respective tuples T1-T2. Depending on the embodiment, an inference may be an anomaly score such as a unit normalized probability or a binary class such as anomaly or non-anomaly. A numeric threshold may be used to convert a numeric anomaly score to a binary class.

This example entails an unsupervised testing phase of the software development lifecycle (SDLC) of anomaly detectors A-C. Unsupervised testing means that ranking of anomaly detectors A-C occurs even if test tuples T1-T2 are unlabeled. In an embodiment, some or all of anomaly detectors A-C were unsupervised trained with an unlabeled training corpus. In an embodiment, anomaly detectors A-C were trained with same or different training corpuses. A label is a binary class or anomaly score of a tuple that is known as correct.

Because test tuples T1-T2 are unlabeled, direct measurement of the respective accuracy of anomaly detectors A-C may be more or less impossible. Herein, accuracy is instead indirectly measured by consensus based on comparison of inferences by each of anomaly detectors A-C to inferences by the others of anomaly detectors A-C. Each of fitness scores 121-122 is a measure of how similar are candidate anomaly detector A’s inferences to respective inferences of anomaly detector B or C.

For example, a maximum for fitness score 121 occurs when inferences I1A and I1B are identical and inferences I2A and I2B are identical anomaly scores or binary classes. A minimum for fitness score 121 instead occurs when inferences I1A and I1B are opposite binary classes (or very dissimilar anomaly scores) and inferences I2A and I2B also are opposite binary classes. Fitness score 121 increases when inferences for a same tuple are similar and decreases when inferences for a same tuple are dissimilar.

A high fitness score from comparing two anomaly detectors increases the ranking of one or both anomaly detectors. Depending on the embodiment, a first anomaly detector is compared to a second anomaly detector once or twice to measure one or two fitness scores. For example in an embodiment, anomaly detector A is designated as the candidate anomaly detector and compared to expert anomaly detector B to measure fitness score 121 with test tuples T1-T2, and then the roles may be reversed with anomaly detector A as expert and anomaly detector B designated as the candidate for comparison to measure another fitness score (not shown) with other test tuples.

Herein, an expert is a reference anomaly detector to which a candidate may be compared when measuring a fitness score for the candidate. The comparison entails comparing sets of inferences by candidate and expert for a same set of test tuples.

In an embodiment, iterations sequentially or concurrently occur. In each iteration, a respective distinct one of anomaly detectors A-C is the candidate. All tests use a same set of test tuples in a same iteration, but different iterations may have different test tuples. A test entails applying an anomaly detector to the current iteration’s test tuples to generate a set of inferences by the anomaly detector. In each iteration, all anomaly detectors A-C are tested without directly generating accuracy scores.

Fitness scores 121-122 are measured when anomaly detector A is the candidate as shown. Other fitness scores are measured when anomaly detectors B-C respectively each is the candidate. In an accelerated embodiment, there is only one iteration; no anomaly detector is designated as the candidate; and there is only one fitness score between each distinct pair of anomaly detectors.

Fitness scores for a candidate anomaly detector are combined to calculate a combined fitness score. For example, fitness scores 121-122 are combined to calculate combined fitness score 131 for candidate anomaly detector A. Likewise based on other measured fitness scores, combined fitness scores 132-133 are respectively calculated for candidate anomaly detectors B-C.

Anomaly detectors A-C may be ranked by combined fitness scores, and a best one or few anomaly detectors having highest combined fitness scores may be selected for further processing such as more intensive training or deployment into production. In one example, the best anomaly detector does not comprise an artificial neural network (ANN).

### 2.0 Example Unsupervised Empirical Ranking Process

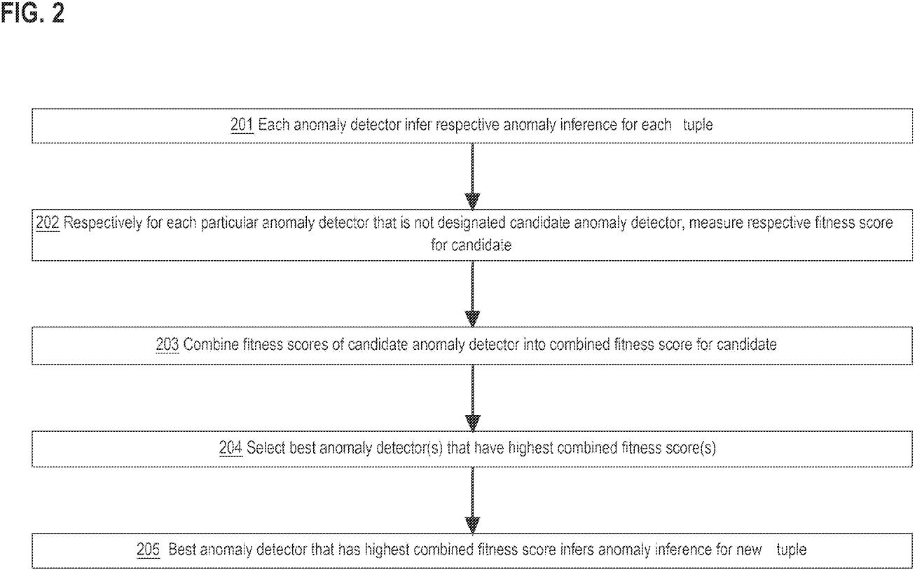

FIG. 2 is a flow diagram that depicts an example unsupervised empirical ranking process that computer 100 may use to select a best one or few anomaly detectors. FIG. 2 is discussed with reference to FIG. 1.

Steps 201-203 perform unsupervised testing of anomaly detectors A-C. Each anomaly detector is the candidate in a respective iteration. Steps 201-203 are repeated for each candidate.

In step 201, each of anomaly detectors, whether the candidate or not, infers a respective anomaly inference for each of test tuple T1-T2.

Respectively for each expert anomaly detector (i.e. not the designated candidate anomaly detector of the current iteration), step 202 measures a respective fitness score between the expert anomaly detector and the candidate. Which mechanism measures fitness scores depends on the type of inferences. If the candidate and expert anomaly detectors both infer binary classes, then step 202 may measure a fitness score by applying F1 scoring or balanced accuracy measurement.

If the candidate anomaly detector infers numeric anomaly scores but the expert anomaly detector instead infers binary classes, then step 202 may measure a fitness score by applying area under precision recall curve (AUPRC), area under receiver operating characteristic curve (AUROC), or precision at n (PAN). If the candidate and expert anomaly detectors both infer numeric anomaly scores, then step 202 may measure a fitness score by applying mean squared error or normalized discounted cumulative gain (NDCG). In an embodiment, step 202 measures a fitness score by instead applying mutual information, cross entropy, logistic loss, log loss, or Kullback-Leibler (KL) divergence.

Step 203 combines fitness scores of the candidate anomaly detector of the current iteration into a combined fitness score for the candidate. For example during the iteration that designates anomaly detector A as the candidate, step 203 measures fitness scores 121-122. A fitness score that compares both expert anomaly detectors B-C as a pair is not measured during that iteration. Depending on the embodiment, step 203 may combine fitness scores by calculating a mean, a median, a statistical mode, or a maximum or minimum.

Step 204 selects one or more best anomaly detector(s) that have highest combined fitness score(s). In step 205, one of the best anomaly detectors infers an anomaly inference for a new tuple that is not one of tuples T1-T2. Step 205 may perform an inference in training, during cross validation, or in production. For example, step 205 may more intensively retrain the best anomaly detector(s) with a much bigger training corpus or deploy the best one(s) into production.

In an embodiment, the process of FIG. 2 does not involve meta-learning, a metamodel, meta-features, supervised training, nor cross validation. In an embodiment, the process of FIG. 2 occurs in polynomial time with respect to a count of anomaly detectors or a count of tuples. In an embodiment, the process of FIG. 2 occurs in an ML pipeline.

### 3.0 Example Unsupervised Testing Process

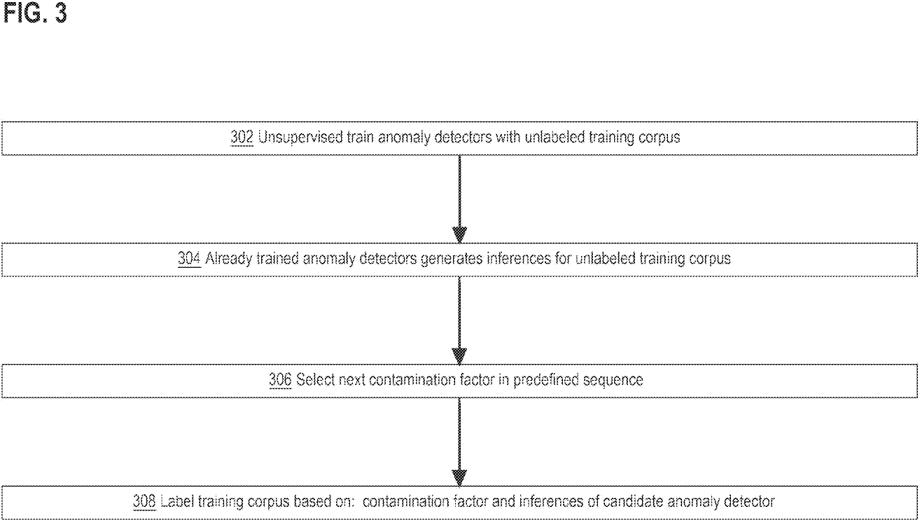

FIG. 3 is a flow diagram that depicts example special activities for unsupervised testing that an embodiment of computer 100 may perform. FIG. 3 is discussed with reference to FIG. 1. The steps of FIG. 3 may supplement the steps of FIG. 2. The steps of FIGS. 2-3 may be combined or interleaved.

Step 302 unsupervised trains anomaly detectors A-C using an unlabeled training corpus that contains at least unlabeled training tuples T1-T2. After step 302, already trained anomaly detectors A-C may be applied in step 304 to the training corpus to generate respective inferences as explained earlier herein. Steps 302 and 304 are preparatory and occur before any of the following nested iterating.

As explained earlier herein, each iteration has a distinct anomaly detector as the candidate. For example, an outer loop may iterate over all of anomaly detectors A-C. For each anomaly detector, an inner loop iterates over a set of predefined distinct contamination factors such as a percentage or fraction of training tuples in a training corpus that are (i.e. correctly or incorrectly) presumed to be anomalous. The presumed contamination factor is not necessarily the actual contamination factor. For example, the actual contamination factor is unknown for an unlabeled training corpus.

Each iteration of the inner loop repeats steps 306 and 308. Step 306 selects the next contamination factor in the predefined sequence to be the contamination factor of the current iteration of the inner loop. Some or all of steps 201-203 of FIG. 2 may be repeated each inner iteration.

With tuples in a training corpus, step 308 does: a) rank the tuples by inference (e.g. anomaly score) of the candidate anomaly detector and b) based on the current contamination factor in the sequence, label the tuples in the training corpus. Each label may include a respective anomaly score and/or binary class that the candidate anomaly detector inferred. The candidate anomaly detector effectively is used to automatically derive labels for the unlabeled training corpus. Each of anomaly detectors A-C may or may not have a contamination factor hyperparameter.

Those derived labels (e.g. anomaly scores) are compared to the inferences of another anomaly detector to measure the fitness of the candidate anomaly detector as a fitness score that contributes to a combined fitness score (i.e. test score) of the candidate anomaly detector as discussed earlier herein.

### 4.0 Exemplary Embodiment

As discussed earlier herein, a fitness score may be scaled from a low of zero to a high of one or 100% that indicates perfect agreement between a set of test labels from the candidate model and a corresponding set of test inferences by another anomaly detector. Fitness herein may be any one of the following mutually exclusive classes of metrics.
Binary-binary metric requires the predictions of the model and the labels to be binary predictions (0 or 1). This includes F1-score or balanced accuracy.
Continuous-binary metric requires only the labels to be binary predictions, while predictions can be probabilities (any real number between 0 and 1). This includes area under precision recall curve (AUPRC), area under receiver operating characteristic curve (AUROC), or precision at n (PAN).
Continuous-continuous metric requires neither labels nor predictions to be binary. This includes mean squared error (typically used for regression) or normalized discounted cumulative gain (NDCG).

The above enumerated classes of metrics are alternative configurations for the following exemplary embodiment of ML model selection based on embodiments presented earlier herein and based on design choices that do not limit those other embodiments. For demonstration, this example uses a continuous-binary metric. Exemplary model selection expects the following inputs.
A training set of size N.
A set M of n candidate models, such as HDBScan, IsolationForest, or others.
A continuous-binary metric, either AUROC, AUPRC or PAN.
A set of contamination factors C to be considered during model selection, typically evenly spaced in the interval [0, 0.5] or [0, 1]

In this exemplary model selection process, a candidate will alternatively be evaluated and evaluate other models. The model selection process implements the following pseudocode algorithm.

1. Train all candidate models in M on the training set.

2. For each candidate model m in M and each contamination factor c in C, construct a set of artificial labels L_{mc} for the training set as follows : Label the N*c training points with the highest anomaly score (as given by model m) as anomalies, and label the remaining points as normal.

3. For each candidate model m in M :
a. For each other candidate model m′ in M \ m, called the expert :
   i. For each contamination factor c in C, compute the score of model m on the training set with respect to the artificial labels L_{m′c} (also called expert labels).
   ii. Average the scores for all contamination factors to produce the expert’s score for model m.
   b. Average all n-1 expert’s scores (by taking the mean, median, etc.) to produce the average score for model m.

4. Select the model with the largest average score.

The above algorithm contains an additional loop over the set C of contamination factors, in order to compute the artificial labels of the experts. Herein, an expert is an anomaly detector that currently is not the candidate. The true contamination factor is unknown, and the average over a predefined set of contamination factors provides an estimate of the test score that would be obtain if the actual contamination factor were known. For example if an anomaly detector has a contamination factor hyperparameter, then that hyperparameter may be set with the actual contamination factor, which increases the accuracy of that anomaly detector.

If the chosen fitness metric instead is continuous-continuous or if the true contamination factor is known, that additional loop can be removed. In that case, the set C as well as the steps (2) and (3a) would be unneeded. Choosing any scoring metric may necessitate modifying the routine accordingly.

Model selection herein is sufficiently generalized for use in a hyperparameter tuning step of an ML pipeline for UAD. For example, two to five best anomaly detectors may be selected from a previous pipeline stage to be more intensively processed in a next pipeline stage.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

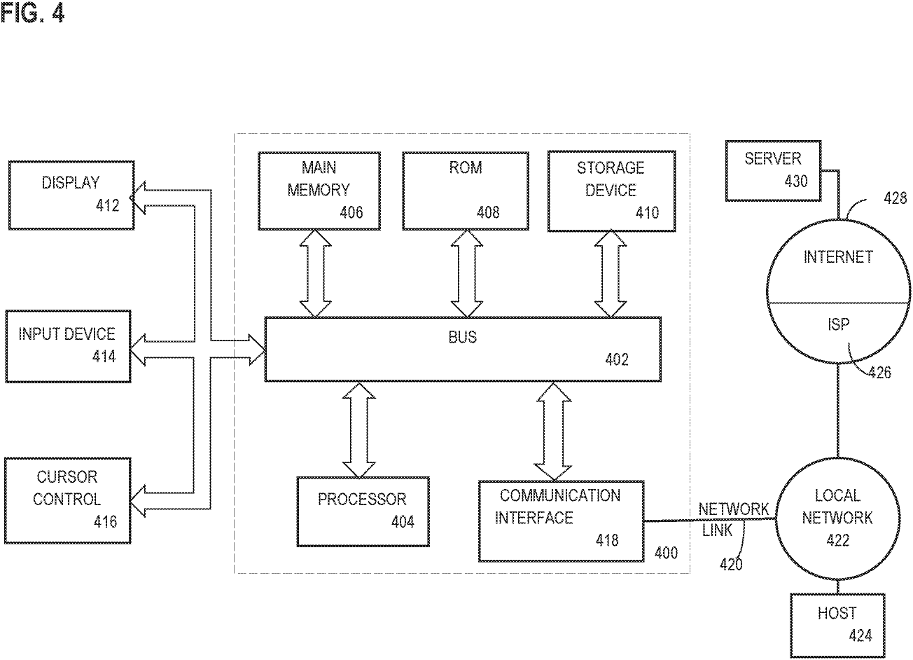

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### Software Overview

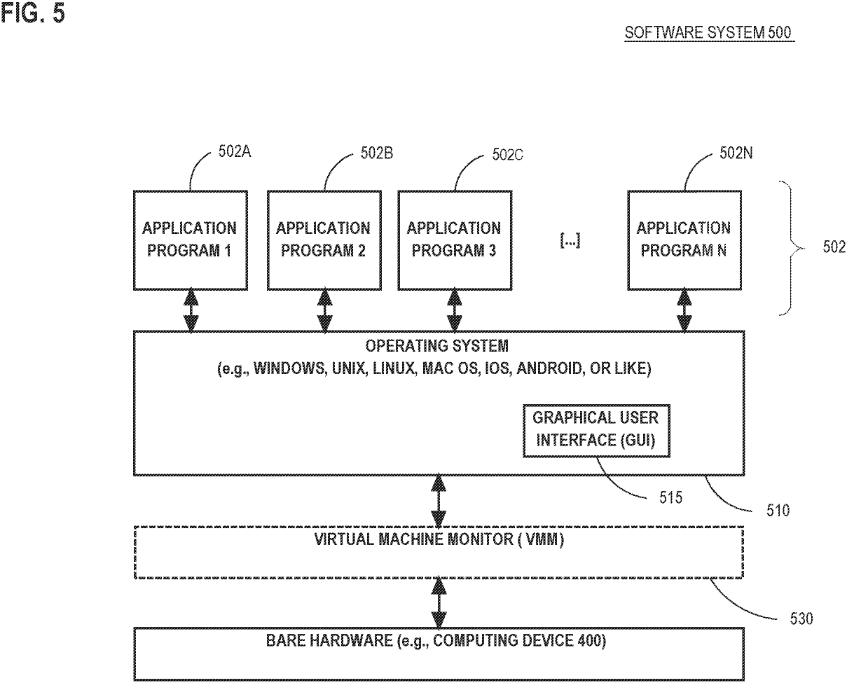

FIG. 5 is a block diagram of a basic software system 500 that may be employed for controlling the operation of computing system 400. Software system 500 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 500 is provided for directing the operation of computing system 400. Software system 500, which may be stored in system memory (RAM) 406 and on fixed storage (e.g., hard disk or flash memory) 410, includes a kernel or operating system (OS) 510.

The OS 510 manages low-level aspects of computer operation, including managing execution of processes, memory allocation, file input and output (I/O), and device I/O. One or more application programs, represented as 502A, 502B, 502C ... 502N, may be “loaded” (e.g., transferred from fixed storage 410 into memory 406) for execution by the system 500. The applications or other software intended for use on computer system 400 may also be stored as a set of downloadable computer-executable instructions, for example, for downloading and installation from an Internet location (e.g., a Web server, an app store, or other online service).

Software system 500 includes a graphical user interface (GUI) 515, for receiving user commands and data in a graphical (e.g., “point-and-click” or “touch gesture”) fashion. These inputs, in turn, may be acted upon by the system 500 in accordance with instructions from operating system 510 and/or application(s) 502. The GUI 515 also serves to display the results of operation from the OS 510 and application(s) 502, whereupon the user may supply additional inputs or terminate the session (e.g., log off).

OS 510 can execute directly on the bare hardware 520 (e.g., processor(s) 404) of computer system 400. Alternatively, a hypervisor or virtual machine monitor (VMM) 530 may be interposed between the bare hardware 520 and the OS 510. In this configuration, VMM 530 acts as a software “cushion” or virtualization layer between the OS 510 and the bare hardware 520 of the computer system 400.

VMM 530 instantiates and runs one or more virtual machine instances (“guest machines”). Each guest machine comprises a “guest” operating system, such as OS 510, and one or more applications, such as application(s) 502, designed to execute on the guest operating system. The VMM 530 presents the guest operating systems with a virtual operating platform and manages the execution of the guest operating systems.

In some instances, the VMM 530 may allow a guest operating system to run as if it is running on the bare hardware 520 of computer system 400 directly. In these instances, the same version of the guest operating system configured to execute on the bare hardware 520 directly may also execute on VMM 530 without modification or reconfiguration. In other words, VMM 530 may provide full hardware and CPU virtualization to a guest operating system in some instances.

In other instances, a guest operating system may be specially designed or configured to execute on VMM 530 for efficiency. In these instances, the guest operating system is “aware” that it executes on a virtual machine monitor. In other words, VMM 530 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprise two or more types of cloud (e.g., private, community, or public) that are bound together by data and application portability.

Generally, a cloud computing model enables some of those responsibilities which previously may have been provided by an organization’s own information technology department, to instead be delivered as service layers within a cloud environment, for use by consumers (either within or external to the organization, according to the cloud’s public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure and applications.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Machine Learning Models

A machine learning model is trained using a particular machine learning algorithm. Once trained, input is applied to the machine learning model to make a prediction, which may also be referred to herein as a predicated output or output. Attributes of the input may be referred to as features and the values of the features may be referred to herein as feature values.

A machine learning model includes a model data representation or model artifact. A model artifact comprises parameters values, which may be referred to herein as theta values, and which are applied by a machine learning algorithm to the input to generate a predicted output. Training a machine learning model entails determining the theta values of the model artifact. The structure and organization of the theta values depends on the machine learning algorithm.

In supervised training, training data is used by a supervised training algorithm to train a machine learning model. The training data includes input and a “known” output. In an embodiment, the supervised training algorithm is an iterative procedure. In each iteration, the machine learning algorithm applies the model artifact and the input to generate a predicated output. An error or variance between the predicated output and the known output is calculated using an objective function. In effect, the output of the objective function indicates the accuracy of the machine learning model based on the particular state of the model artifact in the iteration. By applying an optimization algorithm based on the objective function, the theta values of the model artifact are adjusted. An example of an optimization algorithm is gradient descent. The iterations may be repeated until a desired accuracy is achieved or some other criteria is met.

In a software implementation, when a machine learning model is referred to as receiving an input, being executed, and/or generating an output or predication, a computer system process executing a machine learning algorithm applies the model artifact against the input to generate a predicted output. A computer system process executes a machine learning algorithm by executing software configured to cause execution of the algorithm. When a machine learning model is referred to as performing an action, a computer system process executes a machine learning algorithm by executing software configured to cause performance of the action.

Inferencing entails a computer applying the machine learning model to an input such as a feature vector to generate an inference by processing the input and content of the machine learning model in an integrated way. Inferencing is data driven according to data, such as learned coefficients, that the machine learning model contains. Herein, this is referred to as inferencing by the machine learning model that, in practice, is execution by a computer of a machine learning algorithm that processes the machine learning model.

Classes of problems that machine learning (ML) excels at include clustering, classification, regression, anomaly detection, prediction, and dimensionality reduction (i.e. simplification). Examples of machine learning algorithms include decision trees, support vector machines (SVM), Bayesian networks, stochastic algorithms such as genetic algorithms (GA), and connectionist topologies such as artificial neural networks (ANN). Implementations of machine learning may rely on matrices, symbolic models, and hierarchical and/or associative data structures. Parameterized (i.e. configurable) implementations of best of breed machine learning algorithms may be found in open source libraries such as Google’s TensorFlow for Python and C++ or Georgia Institute of Technology’s MLPack for C++. Shogun is an open source C++ ML library with adapters for several programing languages including C#, Ruby, Lua, Java, MatLab, R, and Python.

### Artificial Neural Networks

An artificial neural network (ANN) is a machine learning model that at a high level models a system of neurons interconnected by directed edges. An overview of neural networks is described within the context of a layered feedforward neural network. Other types of neural networks share characteristics of neural networks described below.

In a layered feed forward network, such as a multilayer perceptron (MLP), each layer comprises a group of neurons. A layered neural network comprises an input layer, an output layer, and one or more intermediate layers referred to hidden layers.

Neurons in the input layer and output layer are referred to as input neurons and output neurons, respectively. A neuron in a hidden layer or output layer may be referred to herein as an activation neuron. An activation neuron is associated with an activation function. The input layer does not contain any activation neuron.

From each neuron in the input layer and a hidden layer, there may be one or more directed edges to an activation neuron in the subsequent hidden layer or output layer. Each edge is associated with a weight. An edge from a neuron to an activation neuron represents input from the neuron to the activation neuron, as adjusted by the weight.

For a given input to a neural network, each neuron in the neural network has an activation value. For an input neuron, the activation value is simply an input value for the input. For an activation neuron, the activation value is the output of the respective activation function of the activation neuron.

Each edge from a particular neuron to an activation neuron represents that the activation value of the particular neuron is an input to the activation neuron, that is, an input to the activation function of the activation neuron, as adjusted by the weight of the edge. Thus, an activation neuron in the subsequent layer represents that the particular neuron’s activation value is an input to the activation neuron’s activation function, as adjusted by the weight of the edge. An activation neuron can have multiple edges directed to the activation neuron, each edge representing that the activation value from the originating neuron, as adjusted by the weight of the edge, is an input to the activation function of the activation neuron.

Each activation neuron is associated with a bias. To generate the activation value of an activation neuron, the activation function of the neuron is applied to the weighted activation values and the bias.

### Illustrative Data Structures for Neural Network

The artifact of a neural network may comprise matrices of weights and biases. Training a neural network may iteratively adjust the matrices of weights and biases.

For a layered feedforward network, as well as other types of neural networks, the artifact may comprise one or more matrices of edges W. A matrix W represents edges from a layer L-1 to a layer L. Given the number of neurons in layer L-1 and L is N[L-1] and N[L], respectively, the dimensions of matrix W is N[L-1] columns and N[L] rows.

Biases for a particular layer L may also be stored in matrix B having one column with N[L] rows.

The matrices W and B may be stored as a vector or an array in RAM memory, or comma separated set of values in memory. When an artifact is persisted in persistent storage, the matrices W and B may be stored as comma separated values, in compressed and/serialized form, or other suitable persistent form.

A particular input applied to a neural network comprises a value for each input neuron. The particular input may be stored as vector. Training data comprises multiple inputs, each being referred to as sample in a set of samples. Each sample includes a value for each input neuron. A sample may be stored as a vector of input values, while multiple samples may be stored as a matrix, each row in the matrix being a sample.

When an input is applied to a neural network, activation values are generated for the hidden layers and output layer. For each layer, the activation values for may be stored in one column of a matrix A having a row for every neuron in the layer. In a vectorized approach for training, activation values may be stored in a matrix, having a column for every sample in the training data.

Training a neural network requires storing and processing additional matrices. Optimization algorithms generate matrices of derivative values which are used to adjust matrices of weights W and biases B. Generating derivative values may use and require storing matrices of intermediate values generated when computing activation values for each layer.

The number of neurons and/or edges determines the size of matrices needed to implement a neural network. The smaller the number of neurons and edges in a neural network, the smaller matrices and amount of memory needed to store matrices. In addition, a smaller number of neurons and edges reduces the amount of computation needed to apply or train a neural network. Less neurons means less activation values need be computed, and/or less derivative values need be computed during training.

Properties of matrices used to implement a neural network correspond neurons and edges. A cell in a matrix W represents a particular edge from a neuron in layer L-1 to L. An activation neuron represents an activation function for the layer that includes the activation function. An activation neuron in layer L corresponds to a row of weights in a matrix W for the edges between layer L and L-1 and a column of weights in matrix W for edges between layer L and L+1. During execution of a neural network, a neuron also corresponds to one or more activation values stored in matrix A for the layer and generated by an activation function.

An ANN is amenable to vectorization for data parallelism, which may exploit vector hardware such as single instruction multiple data (SIMD), such as with a graphical processing unit (GPU). Matrix partitioning may achieve horizontal scaling such as with symmetric multiprocessing (SMP) such as with a multicore central processing unit (CPU) and or multiple coprocessors such as GPUs. Feed forward computation within an ANN may occur with one step per neural layer. Activation values in one layer are calculated based on weighted propagations of activation values of the previous layer, such that values are calculated for each subsequent layer in sequence, such as with respective iterations of a for loop. Layering imposes sequencing of calculations that is not parallelizable. Thus, network depth (i.e. amount of layers) may cause computational latency. Deep learning entails endowing a multilayer perceptron (MLP) with many layers. Each layer achieves data abstraction, with complicated (i.e. multidimensional as with several inputs) abstractions needing multiple layers that achieve cascaded processing. Reusable matrix based implementations of an ANN and matrix operations for feed forward processing are readily available and parallelizable in neural network libraries such as Google’s TensorFlow for Python and C++, OpenNN for C++, and University of Copenhagen’s fast artificial neural network (FANN). These libraries also provide model training algorithms such as backpropagation.

### Backpropagation

An ANN’s output may be more or less correct. For example, an ANN that recognizes letters may mistake an I as an L because those letters have similar features. Correct output may have particular value(s), while actual output may have somewhat different values. The arithmetic or geometric difference between correct and actual outputs may be measured as error according to a loss function, such that zero represents error free (i.e. completely accurate) behavior. For any edge in any layer, the difference between correct and actual outputs is a delta value.

Backpropagation entails distributing the error backward through the layers of the ANN in varying amounts to all of the connection edges within the ANN. Propagation of error causes adjustments to edge weights, which depends on the gradient of the error at each edge. Gradient of an edge is calculated by multiplying the edge’s error delta times the activation value of the upstream neuron. When the gradient is negative, the greater the magnitude of error contributed to the network by an edge, the more the edge’s weight should be reduced, which is negative reinforcement. When the gradient is positive, then positive reinforcement entails increasing the weight of an edge whose activation reduced the error. An edge weight is adjusted according to a percentage of the edge’s gradient. The steeper is the gradient, the bigger is adjustment. Not all edge weights are adjusted by a same amount. As model training continues with additional input samples, the error of the ANN should decline. Training may cease when the error stabilizes (i.e. ceases to reduce) or vanishes beneath a threshold (i.e. approaches zero). Example mathematical formulae and techniques for feedforward multilayer perceptron (MLP), including matrix operations and backpropagation, are taught in related reference “EXACT CALCULATION OF THE HESSIAN MATRIX FOR THE MULTI-LAYER PERCEPTRON,” by Christopher M. Bishop.

Model training may be supervised or unsupervised. For supervised training, the desired (i.e. correct) output is already known for each example in a training set. The training set is configured in advance by (e.g. a human expert) assigning a categorization label to each example. For example, the training set for optical character recognition may have blurry photographs of individual letters, and an expert may label each photo in advance according to which letter is shown. Error calculation and backpropagation occurs as explained above.

### Autoencoder

Unsupervised model training is more involved because desired outputs need to be discovered during training. Unsupervised training may be easier to adopt because a human expert is not needed to label training examples in advance. Thus, unsupervised training saves human labor. A natural way to achieve unsupervised training is with an autoencoder, which is a kind of ANN. An autoencoder functions as an encoder/decoder (codec) that has two sets of layers. The first set of layers encodes an input example into a condensed code that needs to be learned during model training. The second set of layers decodes the condensed code to regenerate the original input example. Both sets of layers are trained together as one combined ANN. Error is defined as the difference between the original input and the regenerated input as decoded. After sufficient training, the decoder outputs more or less exactly whatever is the original input.

An autoencoder relies on the condensed code as an intermediate format for each input example. It may be counter-intuitive that the intermediate condensed codes do not initially exist and instead emerge only through model training. Unsupervised training may achieve a vocabulary of intermediate encodings based on features and distinctions of unexpected relevance. For example, which examples and which labels are used during supervised training may depend on somewhat unscientific (e.g. anecdotal) or otherwise incomplete understanding of a problem space by a human expert. Whereas, unsupervised training discovers an apt intermediate vocabulary based more or less entirely on statistical tendencies that reliably converge upon optimality with sufficient training due to the internal feedback by regenerated decodings. Techniques for unsupervised training of an autoencoder for anomaly detection based on reconstruction error is taught in non-patent literature (NPL) “VARIATIONAL AUTOENCODER BASED ANOMALY DETECTION USING RECONSTRUCTION PROBABILITY”, Special Lecture on IE. 2015 Dec 27;2(1):1-18 by Jinwon An et al.

### Principal Component Analysis

Principal component analysis (PCA) provides dimensionality reduction by leveraging and organizing mathematical correlation techniques such as normalization, covariance, eigenvectors, and eigenvalues. PCA incorporates aspects of feature selection by eliminating redundant features. PCA can be used for prediction. PCA can be used in conjunction with other ML algorithms.

### Random Forest

A random forest or random decision forest is an ensemble of learning approaches that construct a collection of randomly generated nodes and decision trees during a training phase. Different decision trees of a forest are constructed to be each randomly restricted to only particular subsets of feature dimensions of the data set, such as with feature bootstrap aggregating (bagging). Therefore, the decision trees gain accuracy as the decision trees grow without being forced to over fit training data as would happen if the decision trees were forced to learn all feature dimensions of the data set. A prediction may be calculated based on a mean (or other integration such as soft max) of the predictions from the different decision trees.

Random forest hyper-parameters may include: number-of-trees-in-the-forest, maximum-number-of-features-considered-for-splitting-a-node, number-of-levels-in-each-decision-tree, minimum-number-of-data-points-on-a-leaf-node, method-for-sampling-data-points, etc.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
first inferring, by each anomaly detector of a plurality of anomaly detectors, a respective anomaly inference for each tuple of a plurality of tuples;
performing for each candidate anomaly detector of the plurality of anomaly detectors:
measuring, respectively for each particular anomaly detector of the plurality of anomaly detectors that is not the candidate anomaly detector, a respective fitness score for the candidate anomaly detector that indicates how similar are said anomaly inferences of the candidate anomaly detector to said anomaly inferences of the particular anomaly detector, and
combining said fitness scores of the candidate anomaly detector into a combined fitness score for the candidate anomaly detector;
selecting a best anomaly detector of the plurality of anomaly detectors that has a highest combined fitness score; and
second inferring, by the best anomaly detector that has a highest combined fitness score, an anomaly inference for a tuple that is not in the plurality of tuples.

2. The method of claim 1 further comprising repeating a particular step for each contamination factor of a plurality of predefined contamination factors, wherein the particular step is at least one selected from the group consisting of said first inferring and said measuring.

3. The method of claim 1 wherein an unknown of the plurality of tuples is at least one selected from the group consisting of an actual contamination factor and correct labels.

4. The method of claim 1 wherein an anomaly inference of the best anomaly detector is one selected from the group consisting of a numeric anomaly score and a binary detection class.

5. The method of claim 1 wherein said measuring said fitness scores for the best anomaly detector comprises applying at least one selected from the group consisting of: F1 scoring, balanced accuracy measurement, area under precision recall curve (AUPRC), area under receiver operating characteristic curve (AUROC), precision at n (PAN), mean squared error, normalized discounted cumulative gain (NDCG), mutual information, cross entropy, logistic loss, log loss, and Kullback-Leibler (KL) divergence.

6. The method of claim 1 wherein the plurality of anomaly detectors contains a first anomaly detector and a second anomaly detector that has a different value for a same hyperparameter as the first anomaly detector.

7. The method of claim 1 constrained by at least one selected from the group consisting of:
a) the method does not use at least one selected from the group consisting of meta-learning, a metamodel, meta-features, supervised training, and cross validation,
b) the method occurs in polynomial time with respect to a count of at least one selected from the group consisting of the plurality of anomaly detectors and the plurality of tuples, and
c) the method occurs entirely within a machine learning (ML) pipeline.

8. The method of claim 1 wherein said combining said fitness scores of the best anomaly detector comprises calculating at least one selected from the group consisting of an average and a median.

9. The method of claim 1 wherein the best anomaly detector does not comprise an artificial neural network (ANN).

10. The method of claim 1 wherein contamination factor is not a hyperparameter of the best anomaly detector.

11. One or more non-transitory computer-readable media storing instructions that, when executed by one or more processors, cause:
first inferring, by each anomaly detector of a plurality of anomaly detectors, a respective anomaly inference for each tuple of a plurality of tuples;
performing for each candidate anomaly detector of the plurality of anomaly detectors:
measuring, respectively for each particular anomaly detector of the plurality of anomaly detectors that is not the candidate anomaly detector, a respective fitness score for the candidate anomaly detector that indicates how similar are said anomaly inferences of the candidate anomaly detector to said anomaly inferences of the particular anomaly detector, and
combining said fitness scores of the candidate anomaly detector into a combined fitness score for the candidate anomaly detector;
selecting a best anomaly detector of the plurality of anomaly detectors that has a highest combined fitness score; and
second inferring, by the best anomaly detector that has a highest combined fitness score, an anomaly inference for a tuple that is not in the plurality of tuples.

12. The one or more non-transitory computer-readable media of claim 11 wherein the instructions further cause repeating a particular step for each contamination factor of a plurality of predefined contamination factors, wherein the particular step is at least one selected from the group consisting of said first inferring and said measuring.

13. The one or more non-transitory computer-readable media of claim 11 wherein an unknown of the plurality of tuples is at least one selected from the group consisting of an actual contamination factor and correct labels.

14. The one or more non-transitory computer-readable media of claim 11 wherein an anomaly inference of the best anomaly detector is one selected from the group consisting of a numeric anomaly score and a binary detection class.

15. The one or more non-transitory computer-readable media of claim 11 wherein said measuring said fitness scores for the best anomaly detector comprises applying at least one selected from the group consisting of: F1 scoring, balanced accuracy measurement, area under precision recall curve (AUPRC), area under receiver operating characteristic curve (AUROC), precision at n (PAN), mean squared error, normalized discounted cumulative gain (NDCG), mutual information, cross entropy, logistic loss, log loss, and Kullback-Leibler (KL) divergence.

16. The one or more non-transitory computer-readable media of claim 11 wherein the plurality of anomaly detectors contains a first anomaly detector and a second anomaly detector that has a different value for a same hyperparameter as the first anomaly detector.

17. The one or more non-transitory computer-readable media of claim 11 constrained by at least one selected from the group consisting of:
a) the instructions does not cause using at least one selected from the group consisting of meta-learning, a metamodel, meta-features, supervised training, and cross validation,
b) the instructions execute in polynomial time with respect to a count of at least one selected from the group consisting of the plurality of anomaly detectors and the plurality of tuples, and
c) the instructions execute entirely within a machine learning (ML) pipeline.

18. The one or more non-transitory computer-readable media of claim 11 wherein said combining said fitness scores of the best anomaly detector comprises calculating at least one selected from the group consisting of an average and a median.

19. The one or more non-transitory computer-readable media of claim 11 wherein the best anomaly detector does not comprise an artificial neural network (ANN).

20. The one or more non-transitory computer-readable media of claim 11 wherein contamination factor is not a hyperparameter of the best anomaly detector.
